(19) United States
(12) Patent Application Publication
(10) Pub. No.: US 2020/0232592 A1
(43) Pub. Date: Jul. 23, 2020

(54) DEFECT REPAIR USING ADDITIVE MANUFACTURING

(71) Applicant: ExxonMobil Research and Engineering Company, Annandale, NJ (US)

(72) Inventors: Ning Ma, Whitehouse Station, NJ (US); Jevan Furmanski, Califon, NJ (US); Neeraj S. Thirumalai, Easton, PA (US); Jeffrey M. Grenda, Lebanon, NJ (US)

(21) Appl. No.: 16/739,755

(22) Filed: Jan. 10, 2020

Related U.S. Application Data
(60) Provisional application No. 62/795,075, filed on Jan. 22, 2019.

(51) Int. Cl. F16L 58/08; B29C 64/268; B29C 64/153; B23K 26/20; B23K 26/70

(52) U.S. Cl. CPC F16L 58/08; B29C 64/268; F16L 1/26; B23K 26/20; B23K 26/70; B29C 64/153

(57) ABSTRACT

A method for repairing defects on a structure is disclosed herein. The method comprises use of an additive manufacturing head to inject a flowable filler material into the defect. In certain embodiments, the additive manufacturing head can be a laser metal deposition (LMD) head comprising a powder nozzle and a laser. The structure can be, e.g., a pipeline or a pressure vessel used in petroleum, petrochemical, or natural gas applications.

### CROSS-REFERENCE TO RELATED APPLICATIONS

This application claims the benefit of U.S. Provisional Application No. 62/795,075, filed on Jan. 22, 2019, the entire contents of which are incorporated herein by reference.

### FIELD

The present disclosure relates to methods to make in situ repairs to defects in structures. The methods involve additive manufacturing technologies and may be particularly useful in the in situ repair of cracks in pipelines in the oil and gas industries.

### BACKGROUND

Pressure vessels, pipelines, and other structures will often have defects such as flaws or cracks that may reduce the integrity of the structure. These flaws or cracks may be produced during fabrication, manufacturing, or service, the latter resulting from material degradation phenomena such as corrosion or fatigue. There is a need to develop effective, low cost technology to repair and restore the integrity of such structures without significant capital expense or extended operational downtime.

Conventionally, if a flaw is detected in the wall of a pipeline, it is common to take the pipeline out of service, dig down to the pipe, verify the extent of the defect, and then cut the flawed section out of the pipe. A replacement section is then welded into place. In some cases, instead of cutting the pipe, a load-bearing sleeve may be placed around the defect region, but excavation of material to physically access the pipe is still required.

In some cases, periodic inspection of equipment is conducted using non-destructive examination (NDE) methods such as ultrasonic testing, magnetic particle testing, or eddy current testing. If defects or cracks are detected, a fitness-for-service (FFS) assessment is conducted using industry standards such as API 579 or BS 7910 to assess whether the equipment can be operated with the flaw under current operating conditions. Often, the operations must be altered by derating the operating pressures, negatively affecting productivity and throughput. In other cases the equipment will have to be decommissioned and replaced.

There is still a need in the art for improved defect repair that does not require expensive measures, downtime, or altered operations. The present disclosure provides a solution for this need.

### SUMMARY

A method is disclosed herein comprising use of an additive manufacturing head to inject a flowable filler material into a defect on a surface of a structure. The additive manufacturing head can be a laser metal deposition (LMD) head comprising a powder sprayer and a laser. Aligning the LMD head can include setting a focal point of the LMD head to an upper surface of the defect. The structure can be a pipeline or a pressure vessel, for example, or any other suitable structure. The defect can be on an inside of the structure (e.g., within a pipeline) or on the outside (e.g., on the outside of a pressure vessel).

Injecting can include spraying the flowable filler material into the detect. Injecting the flowable filler material can also include creating pressure on the flowable filler material to push the material deeper into the defect. The defect can be at least one of a crack or a dent due to mechanical failure or corrosion attack, or any other suitable defect.

The method can include applying a crack tip filler to fill a crack tip of the crack before injecting the flowable filler material. The crack tip filler can include a relatively lower surface tension and/or lower viscosity than the flowable filler material, wherein surface tension and viscosity are measured by any suitable method. The crack tip tiller can comprise a low melting point eutectic alloy (e.g., having a melting point of about 500° C. or lower according to ASTM 794, such as an aluminum eutectic alloy). In certain embodiments, the crack tip filler can have a lower surface tension and/or lower viscosity than the flowable filler material. Applying the crack tip is filler can include completely coating surfaces of the crack tip.

The method can include forming a crack cap after injecting the flowable filler material, wherein the crack cap is the same material as the structure. The crack cap can be any suitable material, e.g., the same material as the structure or a different material from the structure. Injecting can include spraying powder streams of different powders simultaneously.

In certain embodiments, the flowable filler material can be compatible with base material without phase separation. The flowable filler material can include at least one of austenitic steel, stainless steel, tool steels, nickel alloys, titanium alloys, ceramics, polymers, or other suitable materials. In certain embodiments, the flowable material can have a toughness and/or yield strength that is relatively greater than the toughness of a base material in the structure, wherein toughness and yield strength are measured by any suitable method.

In accordance with at least one aspect of this disclosure, a system for repairing defects in a structure can include an additive manufacturing device that comprises an additive manufacturing head having a laser emitter and a powder nozzle configured to inject flowable tiller material into the defect. The system can include an energy source configured to provide laser energy to the laser emitter, and a fiber optic cable operatively connecting the additive manufacturing device to the energy source to provide laser energy to the laser emitter. The fiber optic cable can be configured to allow the additive manufacturing device to move relative to the laser source to repair remote defects (e.g., defects that are far away from the energy source) in the structure.

The additive manufacturing device can include a powder nozzle and one or more powder supplies for the powder nozzle. It can also include one or more rollers operatively connected thereto to roll on or within the structure, or other suitable means for enabling the additive manufacturing device to move on a surface of or within the structure. The detect can be within a pipeline, for example, or any other suitable structure.

In certain embodiments, the fiber optic cable is about 0.01 miles to about 5 miles long, such as from about 0.05, 0.1, 0.5, or 1 mile to about 2, 3, 4, or 5 miles long. Longer distances are contemplated. A defect detection system (e.g., a non-destructive pipeline integrity and/or imaging system) can be disposed on or within the additive manufacturing device and configured to detect the defect. The system can include alignment module configured to process data from the defect detection system to automatically align the additive manufacturing head with the defect.

In accordance with at least one aspect of this disclosure, a method for repairing a defect in a structure can include moving an additive manufacturing head into the structure to align with the defect, and providing laser energy from an energy source to the additive manufacturing head through a fiber optic cable such that the energy source is remote from the additive manufacturing head. The energy source may not be within or near the structure, for example. Providing laser energy can include providing laser energy to the additive manufacturing head over a distance of about one mile or greater. The structure can be a pipeline, for example, or any other suitable structure.

Methods are disclosed herein that can allow for in-situ defect repair on a structure, such as a pipeline. The methods can include dynamically filling (e.g., through injecting, spraying, or otherwise pushing filler material into) a detect defined on a surface of the structure with a flowable filler material. In accordance with certain embodiments, a structure (e,g., a pipe or pressure vessel) does not need to be cut and load bearing sleeve does not need to be used to repair defects in the structure. Optionally, a pipe can be repaired while in service without stopping flow. In certain embodiments, the flow can be stopped and the pipe taken out of service for repair.

These and other features of the systems and methods of the subject disclosure will become more readily apparent to those skilled in the art from the following detailed description and drawings.

### DESCRIPTION OF THE DRAWINGS

FIG. 1 is a schematic cross-sectional view of a structure having a detect in accordance with this disclosure;

FIG. 2 is a schematic view of the embodiment of FIG. 1, showing the defect repaired in accordance with this disclosure;

FIG. 3 is a schematic of a laser metal deposition assembly attached to a pipe section in accordance with this disclosure;

FIG. 4 is a cross-sectional photograph of experimental results showing filling material disposed within a small crack (e.g., about 0.5 mm to 1 mm wide) after repair in accordance with this disclosure;

FIG. 5A shows stress strain curves of repaired carbon steel in accordance with this disclosure, base steel, and cracked steel; and

FIG. 5B shows an image of repaired carbon steel after testing, which shows that the sample eventually developed necking outside of the repaired zone.

FIG. 6 is a schematic of an embodiment of a system in accordance with this disclosure, showing an additive manufacturing device disposed in a pipe and remote from a laser power source.

### DETAILED DESCRIPTION

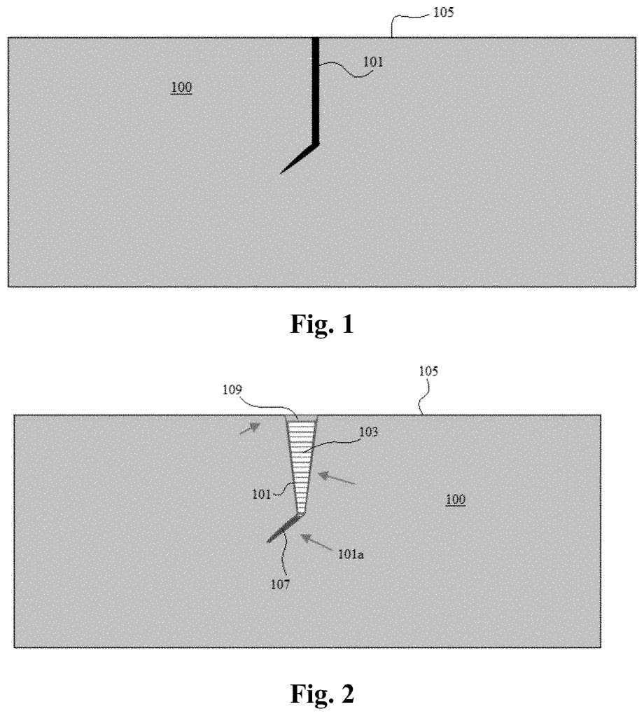

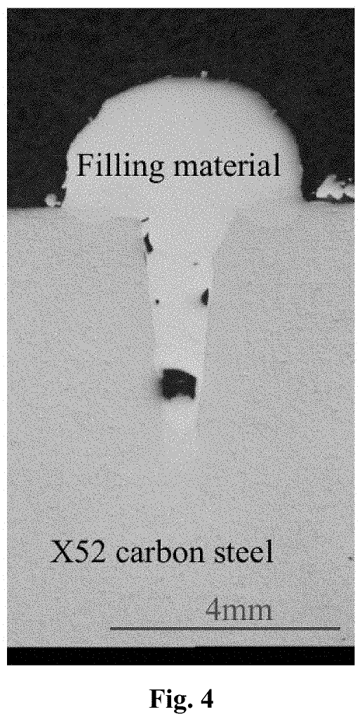

Reference will now be made to the drawings wherein like reference numerals identify similar structural features or aspects. For purposes of illustration and not limitation, an embodiment in accordance with the disclosure is shown in FIGS. 1-3 and the structure to be repaired is designated generally by reference 100. Additional embodiments and/or aspects of this disclosure are shown in FIGS. 4-6. The systems and methods described herein can be used to restore the integrity of an operating structure without taking the structure out of service or replacing the defective part.

The methods disclosed herein can be used to restore the integrity of a structure through the repair of defects such as gouges, voids, cracks, weld flaws, corrosion metal loss, and wall loss features. The methods disclosed herein can make the defects mechanically and chemically invisible. In other words, the mechanical properties (e.g., strength) and chemical properties (e.g., corrosion resistance) in the repaired structure can be the same or even better than the base structure without any defect. Embodiments can be portable and used for defects in both interior and exterior surfaces of the structure. Embodiments are applicable to many material systems including but not limited to steel, metallic alloys, ceramics, and polymer based systems.

Simply pouring liquid metal or other filler material over very small defects less than a few millimeters in width will often not fill the defect due to surface tension of the flowable material. Using an LMD head or other suitable dynamic filling technology (e.g., electron beam welding, fusion torch), the filler material can flow into small defects. The methods and systems disclosed herein can be usefully applied to repair defects, such as cracks, that are less than 50 mm, 40 mm, 30 mm, 20 mm, 10 mm, 5 mm, 3 mm, or 1 mm in width. Larger or smaller defects are contemplated herein.

In a typical LMD process, a focused laser beam is used to melt a powder spray and/or the surface of a metallic substrate and generate a small molten pool, into which a flowable material (e.g., a molten material or a powder) may be fed. The laser beam will melt the flowable material and enable the flowable material to flow all the way to the bottom of the defect and form deposits that are fusion bonded to the metallic substrate. The deposits cool very quickly due to the small melt pool, which generates a very fine grain structure that may be comparable with wrought product. An advantage of additive manufacturing processes such as LMD is that they require relatively low heat input, which helps prevent heat affected zones in the base material and damage to filling materials. Applications of LMD include the repair of worn components, performing near to net shape freedom builds directly from a CAD file, and the cladding of materials. The LMD system can include any suitable system as appreciated by those having ordinary skill in the art (e.g., a Laser Engineered Net Shape or “LENS” system).

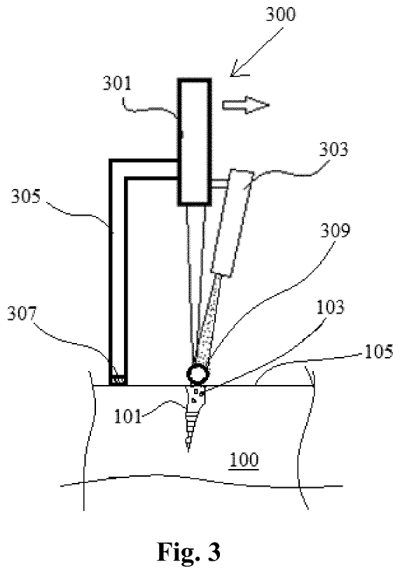

Referring to FIGS. 1-3, a method, e.g., for in-situ defect repair of a structure 100 (e.g., a section of pipeline) can include filling a defect 101 in the structure 100 with flowable filler material 103 (shown in FIG. 3 in the flowable state, shown hardened in FIG. 2). For example, certain embodiments of a method can include aligning an additive manufacturing head 300 with a defect 101 on a surface of a structure 100, and injecting a flowable filler material 103 using the additive manufacturing head 300 into the defect 101.

The structure 100 can be a pipeline or a pressure vessel, for example, or any other suitable structure. The defect 101 may be on a surface 105 of the structure 100. The defect 101 can be on an inside of the structure 101, for example (e.g., within a pipeline as shown in FIG. 6). The defect 101 can be a crack or a dent due to mechanical or corrosion attack, or a fabrication or manufacturing defect. Embodiments can be useful to repair a defect that is substantially two-dimensional (e.g., having an aspect ratio of about 1 width by 20 depth or 1 width by 4 depth, such as from 1:50, 1:30, 1:20, 1:10, or 1:4 to 50:1, 30:1, 20:1, 10:1, or 4:1, including any combination of any minimum or maximum ratio disclosed herein). The defect 101 can be a fine crack (e.g., a very fine crack, less than about 20 mm, 10 mm, 5 mm or 1 mm width).

Injecting can include spraying the flowable filler material 103 into the defect 101. Injecting the flowable filler material 103 can include creating a pressure on the flowable filler material to push the material deeper into the defect.

Filling the defect 101 can include additive manufacturing the flowable filler material 103 into the defect 101 using a laser metal deposition (LMD) head 300 as shown in FIG. 3. LMD is a subset of additive manufacturing processes. As such, the LMD head 300 can include a laser 301 (e.g., a powered source and emitter, or an emitter configured to connect to a remote power source via a fiber optic cable) and a flowable material or powder nozzle 303 (e.g., a sprayer), which can be connected to one or more powder supplies (not shown). In certain embodiments, the powder nozzle 303 can create multiple powder streams and different powders can be fed to the point of deposition simultaneously or at different times.

In certain embodiments, the LMD head 300 can he mounted to a structure 100 via a holder 305. The holder 305 can include a clamp member 307 configured to wrap around or partially around the structure 100 to allow the LMD head 300 to be mounted to the structure 100 (e.g., a pipe). The LMD head 300 can be mounted to be mechanically/automatically or manually moveable relative to the holder 305 to allow motion in one or more axes (e.g., to assist in setting to the focal point 309 location).

Conventionally, one would utilize LMD for deposition at the focal point of the laser, and using it otherwise would not be considered. The methods disclosed here can involve use of LMD for deposition at locations other than the focal point of the laser. For example, the methods herein can include setting a focal point 309 of the laser 301, as shown in FIG. 3, at a location that is level is with the crack opening (e.g., level with surface 105) or slightly above the crack opening (e.g., slightly above surface 105). Aligning the LMD head can include setting a focal point of the LMD head to an upper surface of the defect.

The method can include first detecting the defect 101 in the structure 100 (e.g., using any suitable in-line pipe inspection method where the structure 100 is a pipe). The method can include cleaning the defect 101 before injecting flowable filler material 103 into the defect. Cleaning the defect 101 can include at least one of drilling out the defect 101 or applying a cleaning solution to the detect 101. The defect may he cleaned or drilled out to remove corrosion, for example.

The method can include applying a crack tip filler 107 (e.g., as shown in FIG. 2) to fill a crack tip 101a before injecting the flowable filler material 101. The crack tip filler 107 can have a lower surface tension and/or lower viscosity than the flowable filler material 103, which allows the crack tip filler 107 to flow into even extremely fine crack tips and completely coat the surfaces of the crack tip. Any suitable method for measuring surface tension and/or viscosity of a material as appreciated by those having ordinary skill in the art is contemplated herein (e.g., ASTM standards). The crack tip filler 107 can also have a strength after curing that is close to that of the base material in the structure 100. The crack tip filler 107 can be or include a low melting point eutectic alloy (e.g., aluminum eutectic alloy), an epoxy, or any other suitable low melting point material (e.g., having a melting point of about 500° C. or lower according to ASTM standard, such as). In an embodiment, the crack tip filler 107 completely coats the surfaces of the the crack tip 101a.

The flowable filler material 103 can be any suitable material that is compatible with the base material without phase separation. For example, for titanium pipeline, stainless steel can be excluded due to brittle TiFex intermetallic phase formation that could occur. In certain embodiments, the flowable filler material 103 can comprise austenitic steel, stainless steel, tool steels, nickel alloys, titanium alloys, ceramics, polymers, or other suitable materials. The flowable filler material may be supplied to the LMD head 300 in powder, molten, or other suitable form for dynamic filling). In certain embodiments, injecting can include spraying powder streams of different powders simultaneously. The flowable filler material 103 can fill in the entire body of the crack 101 above the crack tip 101a, and/or any other suitable portion(s) of the crack 101. In to some embodiments, the flowable filler material 103 has a strength after curing that is comparable to the strength of the base material in the structure 100.

In some embodiments, the flowable filler material 103 can have a toughness that is greater than the toughness of the base material in the structure 100. Toughness can be measured in any suitable manner as appreciated by those having ordinary skill in the art (e.g., via an ASTM standard).

In certain embodiments, the method can include forming a crack cap 109 to fill in a top of the crack 101 after injecting the flowable filler material 103 to fill the body 101b of the crack 101. The crack cap 109 can be the same material as the structure 100, or any other suitable material (e.g., the same material as filler material 103). The top of the crack cap 109 can be level or substantially level with the surface 105. The crack cap 109 can be any suitable thickness (e.g., 25%, 20%, 10%, or 5% of the crack length or less).

FIG. 4 shows a cross-sectional photograph of experimental results using the methods herein, with filling material disposed within a small crack in an 8 mm thick plate of X52 carbon steel. A cone-shaped crack in the steel about 6 mm long (the dimension coming out of the page), 1 mm wide, and 4 mm deep was created using Electrical Discharge Machining (EDM). The parameter of LMD process was chosen to obtain the best spatial resolution with low energy input, e.g., about 400 W. Multiple passes of stainless steel 304 filling material were deposited in the crack. The cross section optical image shows that the filling material reaches the bottom of the crack. This experimental result demonstrates that flowable metal can reach the tip of even a very thin crack using LMD techniques. LMD processing parameters (e.g., power of spray and/or laser) and/or scan strategy (e.g., LMD head movement speed and/or direction) can be further optimized to mitigate the defects (shown by the dark color) in the filling material.

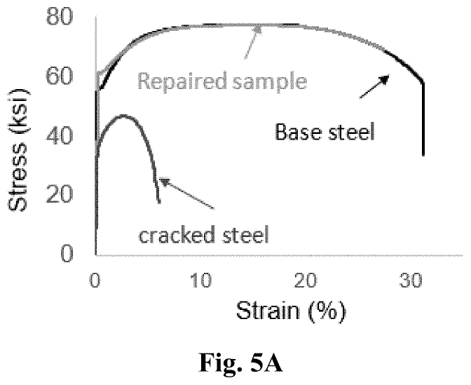

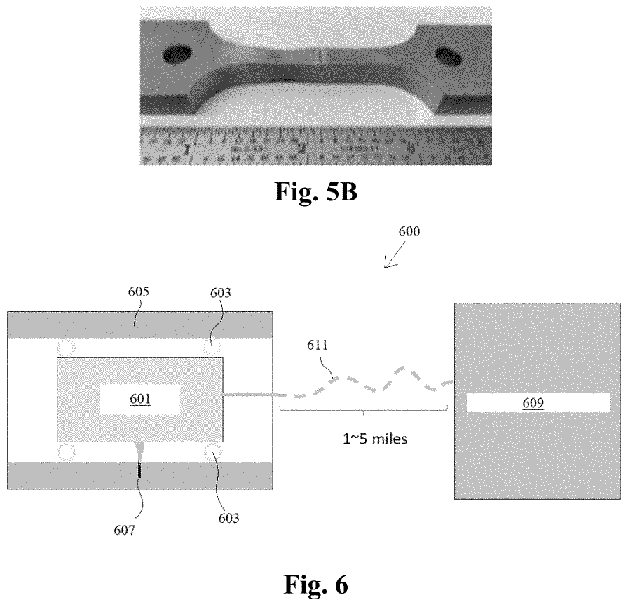

FIG. 5A provides stress-strain curves generated according to ASTM E8 of the base (uncracked) steel, the cracked steel, and the repaired steel. The curves show that the repaired steel has superior mechanical properties. The extra material above the base steel, shown in FIG. 4, was removed before the testing and the thinnest cross section in the tensile gauge was at the location of the repair. The repaired steel demonstrated a higher yield strength than that of base steel. FIG. 5B shows an image of the repaired steel after testing, which shows that the sample eventually developed necking outside of repaired zone. After 2.7% deformation, the stress-strain curve of the repaired steel started to overlap with that of base steel, and the repaired steel eventually failed at a location other than the repair, as can be seen in FIG. 5B. In addition, the stress-strain curve of the repaired steel showed very low yield strength and elongation.

Embodiments can integrate into an inspection system for on-the-spot repair. Certain embodiments can be used free hand as a manual laser/spray pen.

Embodiments can also be used for long distance remote repair. For example, referring to FIG. 6, an embodiment of a system 600 for repairing detects in a structure is shown. The system 600 can include an additive manufacturing device 601 (e.g., including an LMD head 300 and any suitable powder supply). The additive manufacturing device 601 can include an additive manufacturing head (e.g., head 300) having a laser emitter (e.g., laser 301, an end of a fiber optic cable, any other suitable laser source, and/or any suitable conduit and/or optic for directing a laser) The device 601 can include a powder nozzle, e.g., 303. The head can be configured to inject flowable filler material into a defect 607 (e.g., similar to defect 101 described above).

The additive manufacturing device 601 can include a package containing the additive manufacturing head (e.g., 300) having the powder nozzle, and/or one or more powder supplies for the powder nozzle. The additive manufacturing device 601 can include one or more rollers 603 attached thereto and configured to roll on a surface (e.g., within a pipe 605 as shown). The additive manufacturing device 601 can include any suitable package and/or frame configured to hold any suitable additive manufacturing components (e.g., an LMD head and any suitable powder supply connected thereto).

The system 600 can include a remote laser source 609 operatively connected to the additive manufacturing device 601 via a fiber optic cable 611 and configured to provide laser energy to the laser emitter. The fiber optic cable 611 can be configured to allow the additive manufacturing device 601 to move relative to the laser source 609 to repair remote defects 607 in the structure 100. As shown, the fiber optic cable 611 can be one or more miles long (e.g., 1 to 5 miles), or any other suitable length. Such fiber optic cable 611 can allow repair far away from the power source 609, e.g., on an inside surface of a pipe 605 that is buried or otherwise difficult to access (e.g., in a sufficiently long removed pipe section).

Any suitable downhole insertion tools for use in sending the additive manufacturing device downhole and/or locating the additive manufacturing device 601 over a defect 607 to repair the defect 607 (e.g., as shown) is contemplated herein. In certain embodiments, the system 600 can include a defect detection system (e.g., a non-destructive pipeline integrity and/or imaging system) at least partially disposed on or within the additive manufacturing device 601 and configured to detect the defect 607. The system 600 can include alignment module configured to process data. from the defect detection system to automatically align the additive manufacturing head with the defect 607. Any suitable system and/or module disclosed herein can include any suitable computer hardware and/or software configured to perform the described function as appreciated by those to having ordinary skill in the art.

In certain embodiments, one or more pipeline integrity and/or imaging devices can be included in the system 600 (e.g., at least partially disposed on or in the device 601) that can be configured to detect and/or image a defect (e.g., to locate and align the head over the defect for repair). Any suitable pipeline integrity and/or imaging devices and/or methods (e.g., non-destructive) as appreciated by those having ordinary skill in the art can be utilized. Such integrity and/or imaging data can be used to register the additive manufacturing head (e.g., of device 601) relative to the defect, and preform the process (claim wherein the detection method is a non-destructive method).

As shown in FIG. 6, the additive manufacturing device 601 can be inserted into a pipe 605 and located over a defect 607 for repair. The additive manufacturing device 601 can receive laser power through fiber optic cable 611 from the remote power source 609 (which can be at a surface with the user). The laser power received through cable 611 can be sufficient to melt and/or sinter metallic powder.

For example, high laser power, e.g., about 20 kW, was demonstrated successfully to be delivered through optical fiber cable optical fiber for 1 mile distance, while the long distance electrical delivery to operate common arc welding processes (shielded metal arc, gas metal arc, gas tungsten arc) is difficult from the standpoint of power consumption requirements.

Accordingly, embodiments allow a head without the power supply to be sent long distances down piping, for example. A method can include providing power input (e.g., high power laser) to the head through a fiber optic cable as shown. Power input can be any suitable distance (e.g., about 1 to about 5 miles) away from additive manufacturing head.

In accordance with at least one aspect of this disclosure, a method for repairing a defect in a structure can include moving an additive manufacturing head into the structure to align with the defect, and providing laser energy from a power source to the additive manufacturing head through a fiber optic cable such that the power source is remote from the additive manufacturing head. The power source may not be within the structure, for example. Providing laser energy can include providing laser energy to the additive manufacturing head over a distance of about one mile or greater. The structure can be a pipeline, for example, or any other suitable structure.

Methods are disclosed herein that can allow for any suitable detect repair on a structure, e.g., a buried pipeline. The methods can include dynamically filling (e.g., through injecting, spraying, or otherwise pushing filler material into) a defect defined on a surface of the structure with a flowable filler material. In accordance with certain embodiments, a structure (e.g., a pipe or pressure vessel) does not need to be cut and load bearing sleeve does not need to be used to to repair defects in the structure. Optionally, a pipe can be repaired while in service without stopping flow. In certain embodiments, the flow can be stopped and the pipe taken out of service for repair.

Embodiments can include post repair tempering heat treatment to enhance the filling materials mechanical property and bonding with the crack surface. Any other suitable post additive manufacturing treatment is contemplated herein.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The embodiments of the present disclosure, as described above and shown in the drawings, provide for improvement in the art to which they pertain. While the subject disclosure includes reference to certain embodiments, those skilled in the art will readily appreciate that changes and/or modifications may be made thereto without departing from the spirit and scope of the subject disclosure.

1. A method comprising use of an additive manufacturing head to inject a flowable filler material into a defect on a surface of a structure.

2. The method of claim 1, wherein the additive manufacturing head is a laser metal deposition (LMD) head comprising a powder sprayer and a laser.

3. The method of claim 2, wherein aligning the LMD head includes setting a focal point of the LMD head to an upper surface of the defect.

4. The method of claim 1, wherein the defect is on an inside surface of the structure.

5. The method of claim 1, wherein injecting includes spraying the flowable filler material into the defect.

6. The method of claim 1, wherein injecting creates a pressure on the flowable filler material that pushes the material further into the defect.

7. The method of claim 1, wherein the defect is at least one of a crack or a dent due to mechanical failure or corrosion attack.

8. The method of claim 1, wherein the defect is a crack and a crack tip filler is applied to fill a crack tip of the crack before injecting the flowable filler material.

9. The method of claim 8, wherein the crack tip filler has a lower surface tension and/or a lower viscosity than the flowable tiller material.

10. The method of claim 8, wherein the crack tip filler is a low melting point eutectic alloy.

11. The method of claim 1, wherein the structure comprises a base material and the flowable tiller material is compatible with the base material such that there is no phase separation.

12. The method of claim 1, comprising forming a crack cap after injecting the flowable filler material, wherein the crack cap is the same material as the structure.

13. The method of claim 1, wherein the structure is a pipeline or a pressure vessel.

14. The method of claim 1, wherein injecting includes spraying powder streams of different powders simultaneously or consecutively.

15. The method of claim 8, wherein applying the crack tip filler includes completely coating surfaces of the crack tip.

16. The method of claim 1, wherein the flowable filler material comprises at least one of austenitic steel, stainless steel, tool steels, nickel alloys, titanium alloys, ceramics, polymers, or other suitable materials.

17. The method of claim 1, wherein the structure comprises a base material, and the flowable material has a toughness that is relatively greater than the toughness of the base material, wherein toughness is measured by any suitable method.

18. The method claim 1, wherein the structure comprises a base material, and the flowable material has a yield strength that is relatively greater than the yield strength of the base material, wherein yield strength is measured by any suitable method.

19. A system for repairing a defect in a structure, comprising:
an additive manufacturing device comprising an additive manufacturing head having a laser emitter and a powder nozzle configured to inject flowable filler material into the defect;
an energy source configured to provide energy to the laser emitter; and
a fiber optic cable operatively connecting the additive manufacturing device to the energy source, the fiber optic cable configured to allow the additive manufacturing device to move relative to the energy sauce.

20. The system of claim 19, wherein the additive manufacturing device further comprises one or more powder supplies for the powder nozzle.

21. The system of claim 19, wherein the additive manufacturing device is configured to move or roll on along a surface of the structure or inside the structure.

22. The system of claim 19, wherein the structure is a pipeline.

23. The system of claim 19, wherein the fiber optic cable is about 0.01 mile to about 5 miles long.

24. The system of claim 19, further comprising a defect detection system disposed on or within the additive manufacturing device and configured to detect the defect.

25. The system of claim 19, further comprising an alignment module configured to process data from the defect detection system and align the additive manufacturing head with the defect.
